(19) United States
(12) Patent Application Publication
(10) Pub. No.: US 2003/0041139 A1
(43) Pub. Date: Feb. 27, 2003

(54) Event management for a remote network policy management system

(75) Inventors: Mark A. Beadles, Hilliard, OH (US); William S. Emerick, Dublin, OH (US); Kevin A. Russo, Lewis Center, OH (US); Kenneth E. Mulh, Upper Arlington, OH (US); Raymond J. Bell, Mill Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Smartpipes, Incorporated, Redwood City, CA

(21) Appl. No.: 10/219,187

(22) Filed: Aug. 13, 2002

Related U.S. Application Data
(60) Provisional application No. 60/312,382, filed on Aug. 14, 2001.

(51) Int. Cl. G06F 15/173

(52) U.S. Cl. 709/223

(57) ABSTRACT

An event manager for a remote network management system. The event manager provides dynamic response for the purposes of controlling policy updates, generation and deployment. Dynamic events are used to communicate the fact that policy changes/updates/creations have occurred. In prior art systems, a user would simply make a data update, and then the system would retrieve the latest data from the data storage synchronously.

### CROSS-REFERENCE TO RELATED APPLICATIONS

This application is related to copending application Ser. No. ______, “Selection and Storage of Policies in Network Management” (Attorney Docket No. 20063P-001210US), Ser. No. ______, “Policy Engine for Modular Generation of Policy for a Flat, Per-Device Database” (Attorney Docket No. 20063P-001310US), Ser. No. ______, “Device Plug-in System for Configuring Network Devices over a Public Network” (Attorney Docket No. 20063P-001510US) and Ser. No. ______, “Modular Remote Network Policy Management System” (Attorney Docket No. 20063P-001610US), all filed even date herewith and assigned to the same assignee, and all incorporated herein by reference.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to management and control of communication networks and, in particular, to event management for remote management and control of communication networks.

Networks

A communication network typically includes a number of network devices that, among other functions, transmit or receive data. A local area network, commonly referred to as a LAN, is a privately owned network that facilitates communication among the devices coupled to the network via one of several data communication protocols such as Ethernet or FDDI. Multiple LANs are typically interconnected via, for example, private links or satellite transmissions to form a wide area network, commonly referred to as a WAN. Such LANs and WANs are increasingly being coupled to the internet.

Communication network systems are becoming ever more complex. To increase resource sharing and facilitate their supervision, computer systems, such as facsimile machines, desktop computers, printers, etc. are typically coupled to a LAN. The complexity that arises as a result of increasing the number and the variety of systems, which in the aggregate form a computer network, coupled with the variety of communication protocols that such devices are required to support, increase the knowledge base that is often required to manage such networks. The problem is further compounded by the increasing complexity of new generation of high performance network devices and their interoperability as well as by the lack of qualified and well-trained network administrators. To operate and conform to a network's objectives, a network device (e.g. a router) is first configured—i.e., the networking parameters of the device are set to desired values. An inventory as well as a record of the configuration parameters of each configured networked device is typically maintained for future reference. Network devices are often reconfigured (e.g., by changing router ports, routing tables, IP addresses) to accommodate for network expansion or modification—for example, to add a new user to the network.

Device Based Network Management

One conventional method of configuring a networked device is to issue commands which are specific to the device via a computer system. A drawback of the method is that each networked device is configured and subsequently verified separately to ensure its conformity with the desired network objectives. Another drawback of the method is that it requires an extensive knowledge base—of the various network device types—which may become prohibitively large as the number of device types in a network rises.

Outsourcing Network Management

Another known method for managing a communications network is through outsourcing the network management to another commercial entity. For example, WorldCom Inc., located at 500 Clinton Center Drive, Clinton Miss., 39056 offers a network management service based on which a group of network administrators at WorldCom, upon receiving specific requests to manage or configure a network device, transmit related commands and data via the internet to the network device thereby to manage or configure the device. The method, however, involves human intervention and is thus inefficient and unautomated.

Policy Based Network Management

A third known method for managing networked devices is to include a number of individual devices of a given type in a policy domain and apply a set of policies to the domain. Such policy-based methods, however, are only applicable to a limited number of specific device types. Furthermore, in such conventional policy-based network communication systems, policies are defined through a descriptive programming language. The applied policies so defined become attributes of their associated devices and are thus not objects which can be pointed to and thus viewed.

In directory-enabled policy-based network management systems, a directory serves as the central location for storing policies, profiles, user information, network configuration data, and internet protocol (IP) infrastructure data, such as network addresses and server information. Policies in directory-enabled networking (DEN) are defined in terms of rules containing conditions and actions for managing users, network resources, and services/applications.

In DEN, physical details of a network are separated from the logical attributes of the application types. DEN has many key attributes and characteristics that typically enable an associated network to be rapidly reconfigured and operate with other platforms. A directory-enabled network is typically scalable, fault-tolerant, and, preferably recognizes people and application by their associated attributes and characteristics and not by their numerical sequences, such as their IP addresses.

Data stored in the directory of a directory-enabled network are typically in formats derived from standard schemas based on the DEN specification published by a group of companies which are collectively known as the Distributed Management Task Force (DMTF). A schema is a collection of rules defining the relationships among objects representing users, applications, network elements, and network services. Each schema contains rules which govern the organization and logical representation of the schema objects.

Access to directory in DEN is commonly governed by version 3 of the known lightweight directory access protocol (LDAPv3), which is a stripped down version of the X.500 directory services standard.

In a directory-enabled network, network entities and the relationship between such network entities are governed by an information system, known in the art as the common information model (CIM). A CIM contains rules regarding management of, for example, hardware, operating systems, operations, application installation and configuration, security, identity, etc. The CIM which is also defined by the DMTF is a standard object-oriented model that represents objects in terms of instances, properties, relationships, classes and subclasses. A primary goal of the CIM is to present a consistent view of managed networks independent of the protocols and data formats supported by the various devices in and applications running on the networks.

One known directory serving as the central storage location in a directory-enabled network is the Windows 2000 Active Directory™, which is developed by and is available from Microsoft Corporation located at One Microsoft Way, Redmond, Wash., 98052. In addition to serving as the cental policy store, Windows 2000 Active Directory™ provides a framework for, among other function, publishing network services, managing users, computer systems, applications and services, as well as secure intranet and internet network services. Furthermore, Windows 2000 Active Directory™ provides a backbone for distributed security in Windows 2000 and a central service point for administrators to manage network services. Windows 2000 Active Directory™, which is an effective platform for DEN, is based on standard protocols such as Domain Name System (DNS)—which is used to locate servers running Active Directory—LDAPv3 (described briefly above) and Kerberos—which is a security protocol for logon authentication.

The Windows 2000 Active Directory™ includes a schema with definitions for every object class that exists in the directory service. Therefore, the universe of objects that may be represented in the Active Directory™ is extensible. Other information related to the Windows 2000 Active Directory™ features and functions are available from Microsoft corporation. The Active Directory supports Component Object Model (COM) features. COM is a language independent standard that promotes object oriented programming by specifying the interfaces of a component at the binary level.

As stated above, conventional methods of configuring and maintaining a communication network are costly, time-consuming and require expert administrators capable of reliably managing and controlling ever more complex network systems in a timely manner.

### BRIEF SUMMARY OF THE INVENTION

The present invention provides an event manager for a remote network management system. The event manager provides dynamic response for the purposes of controlling policy updates, generation and deployment. Dynamic events are used to communicate the fact that policy changes/updates/creations have occurred. In prior art systems, a user would simply make a data update, and then the system would retrieve the latest data from the data storage asynchronously.

In one embodiment, dynamic events are used to signal that a policy should be generated, where a policy is generated by converting it from a hierarchical directory format into a flat XML database format. Dynamic events are also used to signal whether a device should be configured with policy immediately or at a certain predetermined time. This is contrary to prior systems which would configure a device through direct intervention, or according to a schedule determined outside of the system. Unlike prior art systems, this event management system does not rely on a static data model where a user stores policy data in a store, and then the data is retrieved later at a time not controlled by the system. The present invention provides a system in which policy management is a dynamic process, and is supported by an event management system.

In one embodiment, the event manager provides an event scheduler for scheduling events and an event store for storing events, so that events are not lost in the event of system failure, downtime, etc. An interface to a presentation module is provided for receiving events indicating the timing of generating network policy. A separate interface to a network policy generator is provided for providing events to cause the generation of network policy. Yet another interface to a device plug-in module provides events which include a device configuration event and a policy deployment event.

In one embodiment, each event includes a scheduled date and time for the event and an expiration day and time for the event in the absence of an acknowledgment from the client. A general global unique identification number is used to identify the event. A replace event flag indicates that the previously existing event should be replaced. Finally, the event includes an indication of its priority.

In one embodiment, the management system is multi-layered, modular and stores device configuration data in non-device specific format, which are subsequently translated to device-specific format by lower layers of the management system. The non-device specific format is the same (e.g., XML) as that used to create the policies with the user GUI (e.g., browser) and transport them to the service center over the internet. A database stores a policy directory in a hierarchical format that is separate from a policy store (configuration store) for devices in a flat (non-hierarchical or parallel) format.

### BRIEF DESCRIPTION OF THE DRAWINGS

FIGS. 1A-1F show a client network communications system being managed by the policy-based network management system, in accordance with one embodiment of the present invention.

FIGS. 2A and 2B show various layers of the policy-based network management system of FIG. 1.

FIG. 3 is a block diagram illustrating the use of an event manager according to an embodiment of the invention.

### DETAILED DESCRIPTION OF THE INVENTION

### A. Overview of the Operational Stages of the System

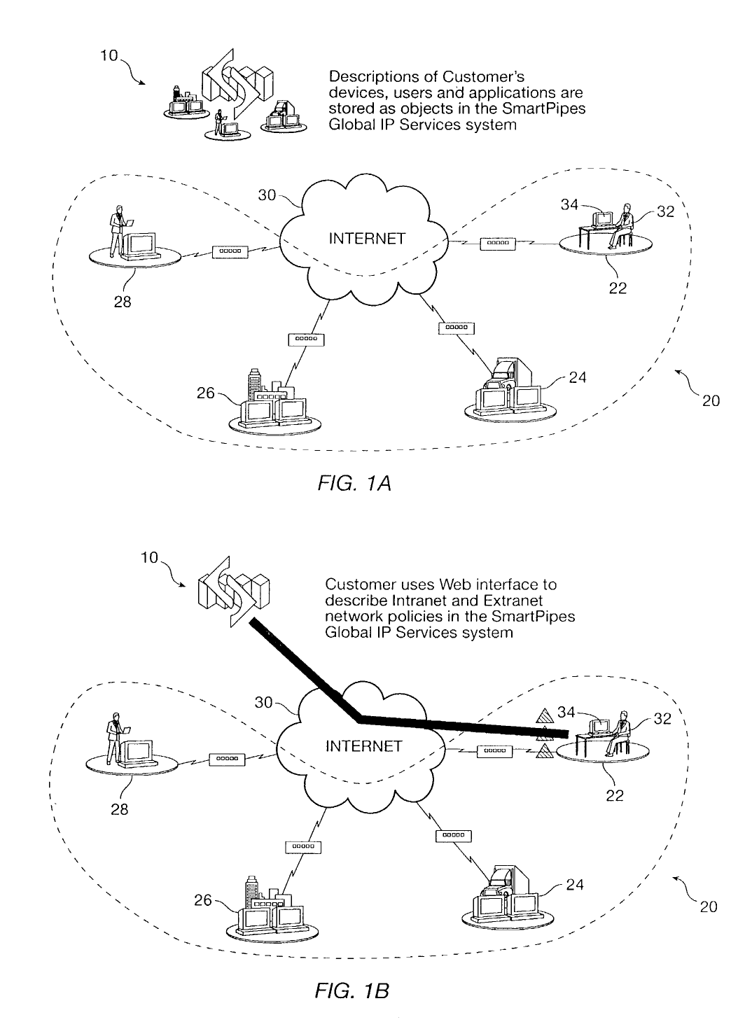

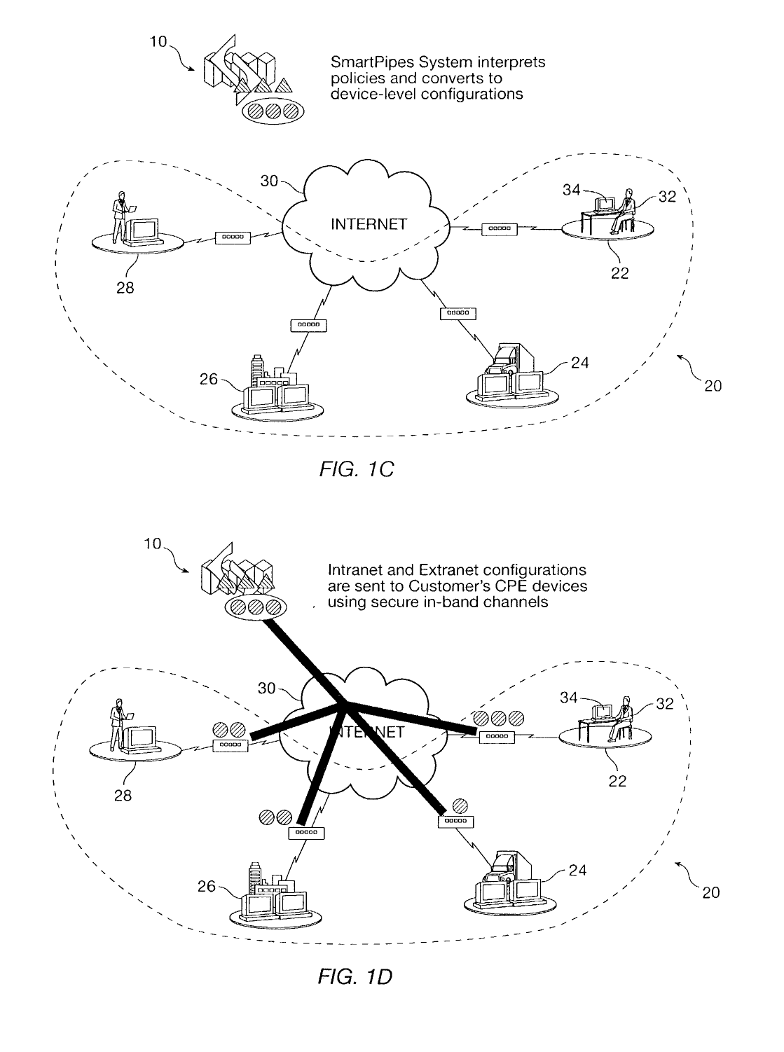

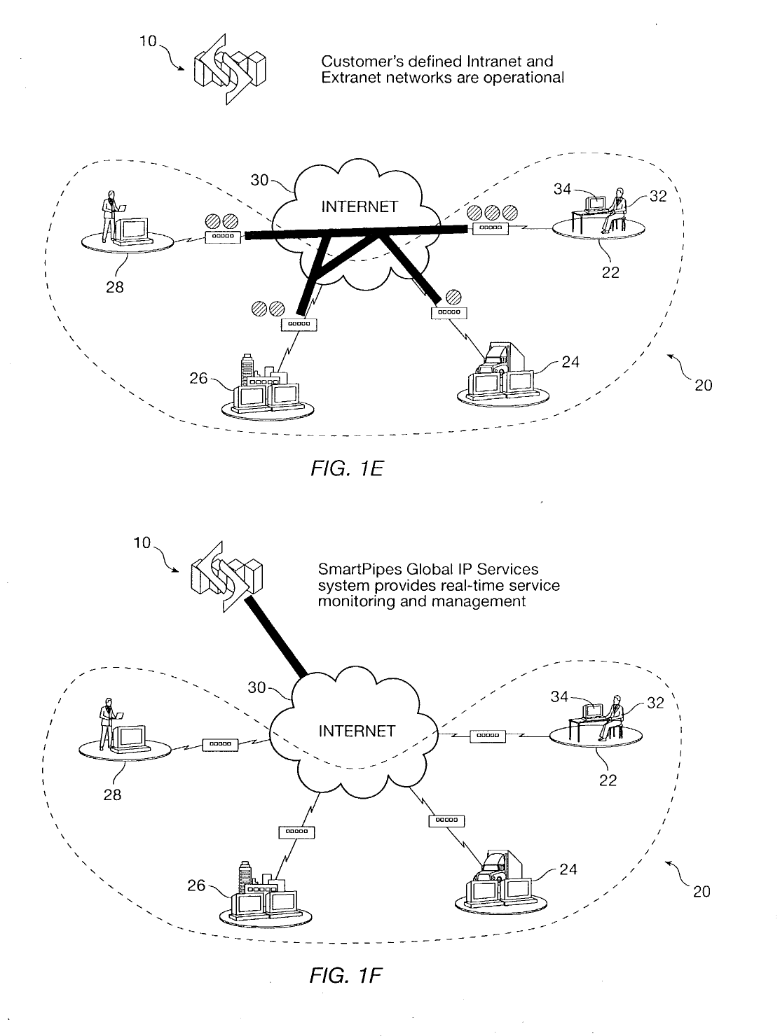

The present invention provides policy-based outsourced network management system at a service center and thus manages and controls a communication network having multiple network device types over a network (e.g., the internet). The management of a typical communications system by the outsourced management system of the present invention is briefly shown in FIGS. 1A-1F, described below.

FIG. 1A shows a customer communications network 20 (shown inside the dashed perimeter lines and composed of network service points 22, 24, 26 and 28) that is coupled to the management system 10 via internet 30. Each network service point may include a number of network devices, such as routers, hubs, printers, facsimile machines, computer systems, etc. In FIG. 1A, internet 30 is shown as the communications medium via which customer 32 using his computer system 34 communicates with management system 10. The customer's devices are stored as objects in the management system 10.

Next, as shown in simplified FIG. 1B, the customer describes intranet and extranet policies for configuring the network communications system 20 under the control and management of system 10. Customer 32 uses a graphical user interface (GUI) on his/her computer system 34, such as an internet browser. The customer describes network policies using the browser, then provides them over the internet to management system 10.

Next, as shown in simplified FIG. 1C, system 10 interprets and converts the selected network policies to device-level configuration data and stores the configuration data in a directory.

Next, as shown in simplified FIG. 1D, system 10 via the internet 30 and using a secure channel, applies the selected intranet and extranet policies to configure the network devices disposed in each of the network service points 22, 24, 26, and 28 to thereby bring the communication network 20 under its control.

FIG. 1E shows that the system 10 has completed configuration of communications network 20, which therefore may carry out its intranet and extranet policies in accordance with the adopted policies.

FIG. 1F shows that after configuring the network devices and applying the network policies, system 10 continues to monitor and manage network communications system 20 via internet 30.

### B. System Overview

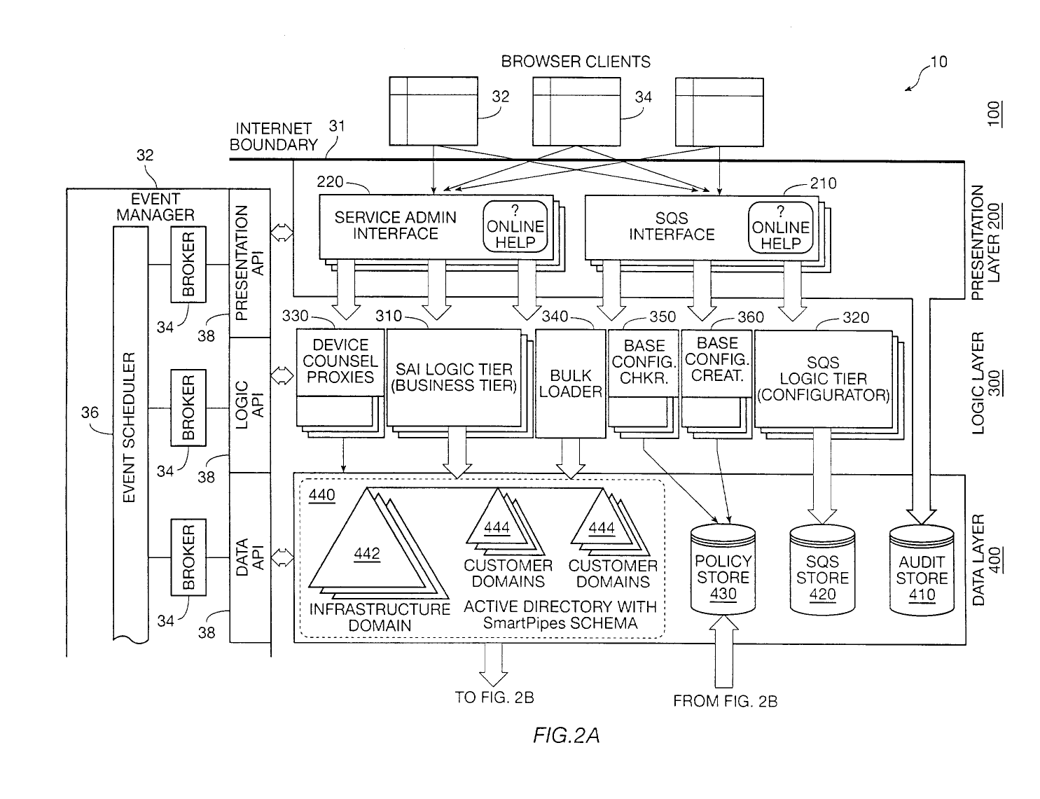

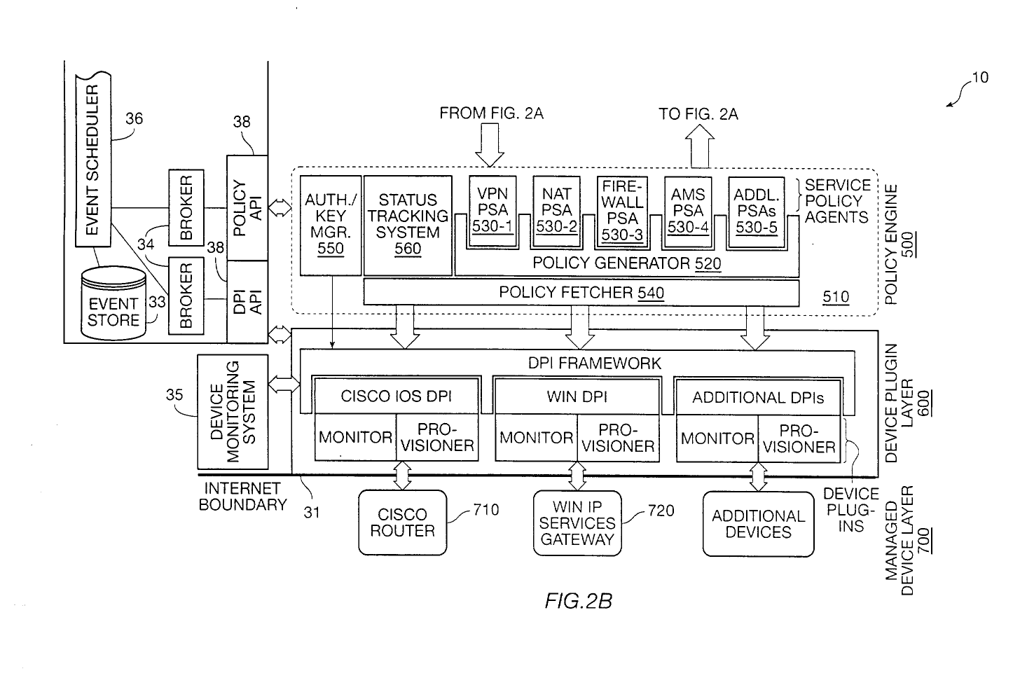

FIGS. 2A and 2B show simplified block diagrams of various layers of management system 10 of FIGS. 1A-1F, in accordance with one embodiment of the present invention. System 10 operates in accordance with a global policy service architecture and includes seven layers, namely, a client layer 100, a presentation layer 200, a logic layer 300, a data layer 400, a policy layer 500, a device plug-in layer 600 and a managed devices layer 700. System 10, also includes, among other modules, an event manager 32 and a device monitoring system 35. System 10 configures, monitors, and controls (i.e., manages) network devices, such as Cisco router 710 and Windows IP Services Gateway 720—in managed devices layer 700—via the internet 31.

System 10 provides a framework for describing internet protocol (IP) services by adopting network policies and managing the network devices (hereinbelow alternatively referred to as managed devices) in layer 700, in accordance with the adopted policies. System 10 is a data-center-based service architecture composed of an array of interacting software, network, and data store elements. System 10 is a dynamic, multi-layered, distributed architecture, and is secure and expandable.

To configure a network device and select and deploy network policies, a user first supplies information regarding his/her network devices (such as the devices' types, model numbers, IP addresses, base configuration data), as well other administrative information (e.g., a contact person at the user's company) to system 10 in one of the following two ways. The user may identify his/her network devices graphically and via an internet browser from various lists that system 10 displays to the user. System 10 collects the user data so identified and stores them in an XML file. Alternatively, the user may create an XML file containing such network identification data and transport that XML file directly to system 10 via the internet. It is understood that when a communication medium other than the internet is used, the user uses a GUI other than an internet browser and may use a file format other than the XML format. It is also understood that the user may create a file using a format other than the XML and which is directly viewable and transportable over the internet. The XML data identifying network devices—supplied by either of the above two methods—is subsequently converted to hierarchical data and written to an Active Directory™ 440.

Next, using a web browser, the user navigates through various policy lists—displayed to the user by system 10—from which lists the user selects and deploys network policies. The selected policy data are stored in Active Directory™ 440. Next, a policy engine in policy layer 500 retrieves policy data stored hierarchically in the Active Directory™ 440, knits different service-based policies together, converts the knitted policies from hierarchical to flat XML format, and thereafter stores the XML policy data which are service-based and device-neutral in policy store 430. Subsequently, an associated device plug-in residing in device plug-in layer 600 of system 10 receives the XML data—stored in the policy store—via the policy engine, translates the XML data to device-specific configuration data and, thereafter, transfers the device-specific configuration data to its associated network device thereby to configure the device and deploy the policies.

### C. Event Manager

Event Manager 32 includes an event store 33. Event store 33 stores events in order to maintain persistence. Event store 33 allows recovery of events in the situation where the event manager server crashes, etc. An event scheduler 36 schedules and acknowledges events. Scheduled events are stored in event store 33, an SQL database. Acknowledged events are used to reschedule or remove events from the database. A number of brokers 34 interface between application interfaces (API) 38 for the various layers and the event scheduler. The event brokers are responsible for handling event type definitions and the publishing and subscribing of events. The event brokers are based on the Active Works™ software from webMethods, Inc. in one embodiment.

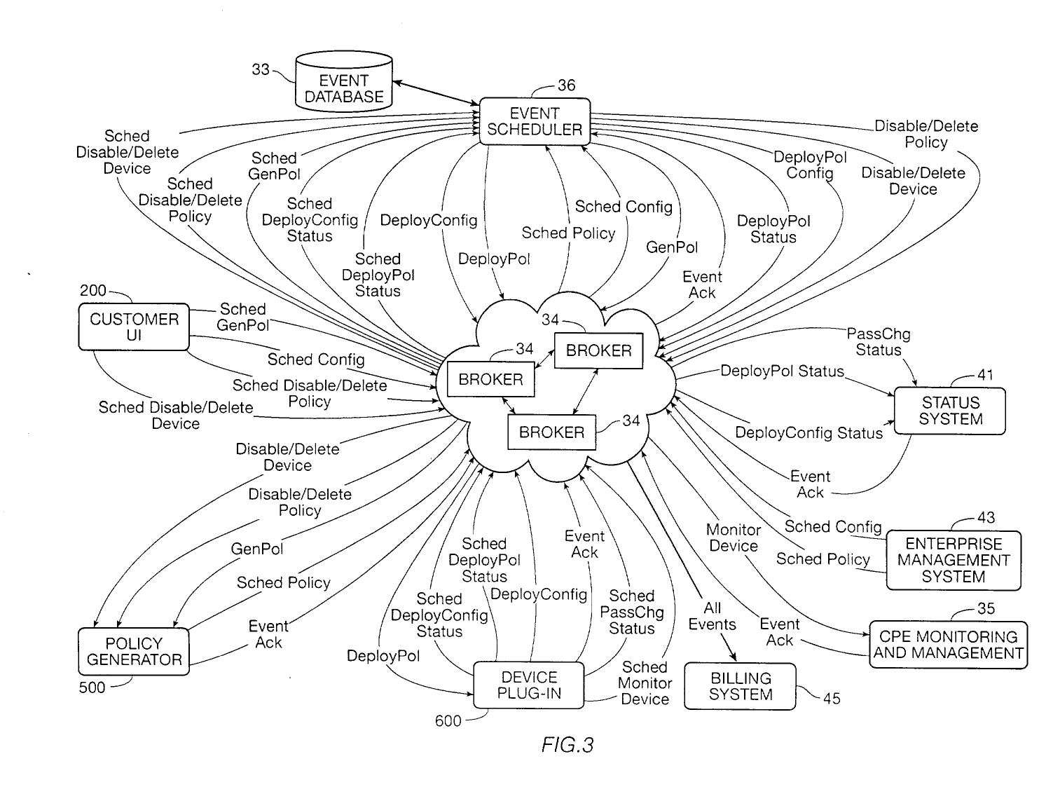

FIG. 3 is a diagram illustrating the flow of data in the event manager. As is shown, the brokers are central to the movement of data, essentially brokering the movement of data between the scheduler and the different clients of the event management system. Such clients include the customer user interface 200, a policy generator 500, device plug-in layer 600, and device monitoring system 35. Also shown are status system 41, an enterprise management system 43, and the billing system 45. Event database 33 is preferably a clustered, replicated relational SQL server database.

Broker Clients

Broker clients publish and subscribe events to a broker. Broker clients can share state. This is useful for load balancing. All broker clients sharing state receive events from the same queue. Only one broker client will receive the event. This allows multiple instances of subscribers to be created without duplicating effort. Broker clients that subscribe to an event that are not sharing state will all receive the same event.

Client Groups

Client groups are supported by ActiveWorks. Each client group only has one member. Items that can be configured at the group level are event types for publishing and/or subscribing, client life cycle which is how long the broker will maintain state for the client, and the client queue type which is how the events are stored. Storage options are volatile, persistent, and guaranteed.

Events

All the events are self-describing. The maximum event size is 8 MB. All events are stored in guaranteed storage. This prevents event loss through a broker failure and restart. ActiveWorks does not natively support self-describing events. Self-describing events are accomplished by using a single string field in each event that contains a XML document that describes all of the SmartPipes fields of the event and the data contained in them.

Client Interface

The client interface abstracts the ActiveWorks API from the application. This simplifies the interface for the application and allow the ActiveWorks API to change without recoding the application. The client interface is be configured via registry settings to handle failover.

Event Scheduler

The event scheduler subscribes to schedule and acknowledge events. Schedule events are stored in a SQL database. Acknowledge events are used to reschedule or removed the events from the scheduler.

Event Scheduling

The events are sorted by type, date/time of schedule publishing, and priority. A NULL date/time means publish the event immediately. The event scheduler will periodically query the event store for events that need to be published or rescheduled. The query period is configured via the registry.

Acknowledge Events

Acknowledge events are used to reschedule the event or remove the event from the scheduler. The published date and time and the event GUID is used to match the acknowledge event with the schedule event.

Event Retry

A fail counter is kept for each event. This is incremented each time the event is negatively acknowledged.. A configured maximum retry interval is applied to every negatively acknowledged event before it is scheduled again. All negative acknowledgments received during the retry interval are masked. The fail count however is incremented. This prevents a malicious subsystem from generating scheduled events and hence reduces the possibility of having duplicate events. There is a configured maximum retry count for each event. When this maximum is reached an alarm will be sent to the Enterprise Management System. The event will be marked as undeliverable from the event database.

Event Expiration

Each event will have has an expiration date/time. When the event expires and has not been acknowledged, an alarm is sent to the Enterprise Management System. This is accomplished by writing an event to the Windows Event Log. The event will continue to be rescheduled upon receipt of negative acknowledgments until it is positively acknowledged.

Event Replacement

Events whose schedule date has not yet arrived can be replaced. For a replacement event, the GenericGuid field should match exactly with the GenericGuid sent by the application when the event was sent for scheduling. Also, the ReplaceEvent flag should be set to TRUE. The event scheduler will replace the existing event in the Event Store with the new “replacement” event. Note that the replacement will be done if and only of the reschedule date for the event has not yet arrived.

Priority

Priority is used by the event scheduler to break ties for scheduling. Ties occur when two or more events are scheduled for the same time. Alternatively, priority and subscription filters can be used to prioritize applications. For example, there may be 3 generators dedicated to high priority requests and 3 dedicated to low priority requests. High priority generators may process low priority requests if they are not busy. Otherwise, low priority requests will have to wait until a low priority generator is available. Priority will be stored as an long integer. Lower numbers will have a higher priority. One will be the highest priority. Priority is not implemented in the current version.

Event Processing

An event is not acknowledged until it is processed by the subscriber. This prevents event from being lost without being processed. The Event Scheduler will retain the event until it has been successfully acknowledged. Clients can use the event scheduler to have the event retried periodically if it is not acknowledged. A positive acknowledge event should be used to remove the event from the event scheduler. A negative acknowledge event will cause the event to be rescheduled. Unacknowledged events will not be automatically rescheduled.

Broker Failure

A broker failure is hidden from the client. The client interface will automatically connect to another broker. If an error is returned to the client, none of the brokers are available.

An example of the fields of an event are set forth below. The fields in bold are required by the event scheduler.

1. Schedule Generate Policy

Name:

SchedGeneratePolicy

Publisher:

Customer UI

Subscriber:

Event Scheduler

Fields:

PolicyListPointer—List of distinguished names of the customer or policies that changed and need to be generated.

TimeStamp—time stamp used to synchronize with the directory replication.

DeployScheduleDate—The date/time that this event should be scheduled.

DeployExpireDate—The date/time that this event expires and an alarm should be sent if it has not been acknowledged.

DeployGenericGuid—The unique id used to identify this event. This is provided by the application.

DeployReplaceEvent—Flag used to determine if this event should be replaced if it already exists in the Event Store.

DeployPriority—the priority of the event.

ScheduleDate—The date/time that this event should be scheduled.

ExpireDate—The date/time that this event expires and an alarm should be sent if it has not been acknowledged.

GenericGuid—The unique id used to identify this event. This is provided by the application.

ReplaceEvent—Flag used to determine if this event should be replaced if it already exists in the Event Store.

Priority—the priority of the event.

A list of other event types follows:

2. Schedule Delete/Disable Policy

3. Schedule Delete/Disable Device

4. Schedule Router Password Change

5. Schedule Router Base Configuration Deployment

6. Schedule Router Policy Deployment

7. Schedule Windows Password Change

8. Schedule Windows Policy Deployment

9. Schedule Deploy Base Configuration Status

10. Schedule Deploy Policy Status

11. Schedule Password Change Status

12. Schedule Monitor Router

13. Schedule Monitor Windows Edge Device

14. Event Acknowledge

15. Generate Policy

16. Delete/Disable Policy

17. Delete/Disable Device

18. Deploy Router Password Change

19. Deploy Router Base Configuration

20. Deploy Router Policy

21. Deploy Windows Password Change

22. Deploy Windows Policy

23. Deploy Base Configuration Status

24. Deploy Policy Status

25. Password Change Status

26. Monitor Router

27. Monitor Windows Edge Device

Policy Generator

The Policy Generator API to the Event Manager allows the Policy Generator to send and receive events. In one embodiment, the Policy Generator to mimic an asynchronous receive event environment in order to be able to gracefully stop the generator. If one or more worker threads are blocked on a synchronous receive event method, it is not possible to gracefully shut down the generator. In order to mimic an asynchronous environment, each worker thread will spawn a receive event thread that will call the synchronous receive event method. The worker thread waits for either the receive event thread to signal that an event has arrived or the quit event to be signaled. If an event has arrived, the worker thread processes the event and tells the receive event thread to receive another event. If the quit event is received, the worker thread uses the method provided by the Event Manager API that allows an outstanding synchronous receive event call to be “canceled”. This allows the Policy Generator and all of it's worker threads to be stopped gracefully.

When the Generator successfully generates and stores a policy, it notifies the Event Scheduler that the event was processed successfully by sending a positive acknowledgment event. If an event is received and is not able to be processed, the Policy Generator sends a negative acknowledgment event to the Event Scheduler. The Event Scheduler applies the set of retry or failure rules defined for this type of event. This may include re-notifying the Generator of the event after a retry interval. The Generator will not know the difference between receiving an event for the first time and receiving it due to a retry rule.

The Event Manager API provides support for load balancing events across multiple instances of the Policy Generator. This load balancing capability also guarantees that only one Policy Generator will be notified of a given event. The Policy Generator will be using this feature of the API in order to leverage the load balancing and fault tolerance benefits provided.

Generation Events

There are three types of Generation events that the Policy Generator can receive from the Event Manager. Each is described below.

1. Generate Policy Event

The Generator Policy event is sent by the Administrative interface when a piece of policy is changed. A Generate Policy event may signal that policy has changed either at an organizational unit (OU) object level or a policy object level. If it is at the OU object level, the Generator must determine all of the policies contained within the OU object and then generate XML policy schema for each. Each Policy Generation thread treats an event as its Unit of Work. Since a single thread is coordinating policy generation for a single event, the Generator will generate XML policy schema serially for each policy object beneath an OU object. If at a later time it is decided that this serial processing is forcing policy generation for an OU object to take too much time, the design could be changed to allow XML policy schema for all policy objects to be generated in parallel. The data that must accompany the generate policy event is as follows:

| Fields | Description |
|---|---|
| PolicyListPointer | The OU or a list of Policy DNs that signify what set |
| | of policies should be regenerated. |
| Timestamp | The timestamp on the Policy object. This is used |
| | by the Generator to assure that the policy it has re- |
| | trieved from a particular server has been repli- |
| | cated and is up to date. |
| DeployNow | Flag indicating whether or not this policy needs to |
| | be deployed immediately. This usually would sig- |
| | nify a bug fix. |
| ScheduleDateTime | This is a date that represents the earliest that this |
| | policy should be deployed. The Admin interface will |
| | adjust this date taking maintenance windows into |
| | account. |
| ExpireDateTime | The date and time that the maintenance window |
| | closes. |
| DeleteOnExpire | Identifies whether or not this event should be de- |
| | leted when it expires. |
| DeployPriority | This will be placed in the Priority field on the De- |
| | ploy Policy event. |
| PublishedDateTime | Used when acknowledging this event. |
| EventGuid | The Guid representing this event in the Event |
| | Scheduler database. The Generator will use this to |
| | either positively or negatively acknowledge this |
| | event. |
| Priority | The priority of this event. This field will not be used |
| | Phase I. |

2. Disable/Delete Device Event

The Disable/Delete Device event is sent by the Administrative interface when a device is either disabled or deleted. The Generator will treat both states the same way. In one embodiment, the Generator generate a “null” policy for the device affected and store it in the Config Store but will not attempt to remove the device from any other device's policy. This “null” policy will signal the Plug-In to remove all policy from this device. The “null” policy will consist of an XML document with no policy elements. In another embodiment, the Generator determines all policies this device is associated with and generates policy for each by invoking the appropriate PSAs just as with a Generate Policy event. This insures that the disabled/deleted device is removed from all device policies in which it is a destination device.

| Attribute | Description |
|---|---|
| Device Pointer | The Device GUID of the device to be deleted/ |
| | disabled. |
| Timestamp | The timestamp on the Device object. This is used |
| | by the Generator to assure that the device it has re- |
| | trieved has been replicated and is up to date. |
| DeployNow | Flag indicating whether or not this policy needs to |
| | be deployed immediately. This usually would sig- |
| | nify a bug fix. |
| ScheduleDateTime | This is a date that represents the earliest that this |
| | policy should be deployed. The Admin interface will |
| | adjust this date taking maintenance windows into |
| | account. |
| ExpireDateTime | The date and time that the maintenance window |
| | closes. |
| DeleteOnExpire | Identifies whether or not this event should be de- |
| | leted when it expires. |
| DeployPriority | This will be placed in the Priority field on the De- |
| | ploy Policy event. |
| PublishedDateTime | Used when acknowledging this event. |
| EventGuid | The Guid representing this event in the Event |
| | Scheduler database. The Generator will use this to |
| | either positively or negatively acknowledge this |
| | event. |
| Priority | The priority of this event. This field will not be used |
| | Phase I. |

3. Disable/Delete Policy Event

The Disable/Delete Policy event is sent by the Administrative interface when a policy is either disabled or deleted. The Administrative interface also includes in the event a list of devices that are affected by this change. For each device, the Generator retrieves the appropriate policy definition(s) from the Config Store for each device and uses these as the basis for the new device policy. Searching for the policy by guid (which is provided in the event), the Generator finds and deletes the specified policy within the retrieved version(s) and re-sorts the definition by policy priority in case the order has changed. It then adds the updated policy definition to the Config Store as a new version. Lastly, the Generator notifies the Plug-In that the policy has changed. The Generator is able to handle this event by itself without needing to utilize the PSAs.

| Attribute | Description |
|---|---|
| Policy GUID | The Policy GUID of the policy that has been de- |
| | leted/disabled. |
| DeviceListPointer | A list of device GUIDs that reflect all of the de- |
| | vices that are involved in the deleted/disabled pol- |
| | icy. The Generator will use this list in order to re- |
| | trieve policies from the Config Store and remove |
| | the deleted/disabled policy. |
| Timestamp | The timestamp on the Policy object. This is used by |
| | the Generator to assure that the device it has re- |
| | trieved has been replicated and is up to date. |
| DeployNow | Flag indicating whether or not this policy needs to |
| | be deployed immediately. This usually would sig- |
| | nify a bug fix. |
| ScheduleDateTime | This is a date that represents the earliest that this |
| | policy should be deployed. The Admin interface will |
| | adjust this date taking maintenance windows into |
| | account. |
| ExpireDateTime | The date and time that the maintenance window |
| | closes. |
| DeleteOnExpire | Identifies whether or not this event should be de- |
| | leted when it expires. |
| DeployPriority | This will be placed in the Priority field on the De- |
| | ploy Policy event. |
| PublishedDateTime | Used when acknowledging this event. |
| EventGuid | The Guid representing this event in the Event |
| | Scheduler database. The Generator will use this to |
| | either positively or negatively acknowledge this |
| | event. |
| Priority | The priority of this event. This field will not be used |
| | Phase I. |

Acknowledging Events

The last thing the Generator does in the policy generation process is to acknowledge the generation event. If the generation was successful, the Generator sends a positive acknowledgment and the Event Scheduler deletes the event from its database. If any step of the generation fails, the Generator sends a negative acknowledgment event to the Event Scheduler. This causes the Scheduler to apply any retry rules that are associated with this event type such as “retry the event up to five times waiting one minute between retries”. The fields required by the Event Acknowledge event are:

| Fields | Description |
|---|---|
| EventName | The name of the event being acknowledged. |
| EventGUID | The GUID that identifies this event in the Event |
| | Scheduler database. |
| DeviceGUID | The GUID that identifies the device that this event is |
| | related to. |
| PublishedDateTime | The datetime that the event being acknowledged was |
| | published. |

As will be understood by those of skill in the art, the present invention may be embodied in other specific forms without departing from the essential characteristics thereof. Accordingly, the forgoing description is intended to be illustrative, but not limiting, of the scope of the invention which is set forth in the following claims.

What is claimed is:

1. A method for managing policy for a network, comprising:
dynamically detecting a user input of a network policy description as an event; and
automatically generating a network policy responsive to said user input.

2. The method of claim 1 further comprising:
dynamically detecting a change to said network policy description as an event; and
automatically regenerating said network policy responsive to said change.

3. The method of claim 1 further comprising:
dynamically determining when a network policy should be deployed; and
configuring a device with said network policy responsive to said determining.

4. The method of claim 1 wherein said automatically generating comprises:
creating a separate flat file for each device impacted by said network policy.

5. An event manager for a remote, modular network management system, comprising:
an event scheduler for scheduling events;
an event store for storing events;
an interface to a presentation module for receiving events indicating a timing for generating a network policy; and
an interface to a network policy generator for providing a network policy generating event.

6. The event manager of claim 5 further comprising:
an interface to a device plug-in module for providing events including a device configuration event and a policy deployment event.

7. The event manager of claim 5 wherein an event is not acknowledged by a module until said event is completed.

8. The event manager of claim 5 wherein each event includes:
a scheduled date and time for the event;
an expiration date and time for the event in the absence of an acknowledgment;
a generic global unique identification number to identify the event;
a replace event flag to indicate if a previously existing event should be replaced; and
a priority for the event.

9. An event manager for a remote, modular network management system, comprising:
an event scheduler for scheduling events;
an event store for storing events;
an interface to a presentation module for receiving events indicating a timing for generating a network policy;
an interface to a network policy generator for providing a network policy generating event; and
an interface to a device plug-in module for providing events including a device configuration event and a policy deployment event;
wherein an event is not acknowledged by a module until said event is completed.
wherein each event includes
a scheduled date and time for the event,
an expiration date and time for the event in the absence of an acknowledgment,
a generic global unique identification number to identify the event,
a replace event flag to indicate if a previously existing event should be replaced, and
a priority for the event.
